(19) United States
(12) Patent Application Publication
(10) Pub. No.: US 2024/0316669 A1
(43) Pub. Date: Sep. 26, 2024

(54) CONTROL DEVICE, WELDING SYSTEM, AND PROGRAM

(71) Applicant: FANUC CORPORATION, Yamanashi (JP)

(72) Inventors: Shigeo YOSHIDA, Yamanashi (JP); Sayuki KASHIWAGI, Yamanashi (JP)

(73) Assignee: FANUC CORPORATION, Yamanashi (JP)

(21) Appl. No.: 18/579,225

(22) PCT Filed: Jul. 30, 2021
(86) PCT No.: PCT/JP2021/028486

§ 371 Date: Jan. 12, 2024

(51) Int. Cl. B23K 9/067

(52) U.S. Cl. CPC B23K 9/067

(57) ABSTRACT

A control device according to an embodiment comprises: an input/output unit; a measurement unit; and a processing unit. The input/output unit configured to output first information instructing start of welding to an arc welder and receive input of second information indicating generation of an arc by the arc welder. The measurement unit configured to measure a time from the output of the first information to the input of the second information. The processing unit configured to perform predetermined processing when the time or a statistic of the times is equal to or less than a first threshold.

### TECHNICAL FIELD

The present invention relates to a control device, a welding system, and a program.

### BACKGROUND ART

When an arc welder starts welding in a state where the wire is in contact with the workpiece (hereinafter, ‘starting welding in a state where the wire is in contact with the workpiece’ is referred to as “touch start”), start failure and tip welding are likely to occur. This is known as a factor that deteriorates welding quality. As a method for avoiding this, there is known a method in which, when it is determined that a touch start is performed, the wire is reversely run to avoid the touch start at the end of welding before the welding point (Patent Document 1). However, according to this method, even if a desired distance between the tip and workpiece cannot be obtained, welding is continued as is. It cannot be said that this can avoid deterioration of welding quality.

### CITATION LIST

### Patent Document

Patent Document 1: Japanese Patent No. 4428073

### DISCLOSURE OF THE INVENTION

### Problems to be Solved by the Invention

A control device capable of improving welding quality as compared with conventional art is desired.

### Means for Solving the Problems

A control device of the present disclosure includes an input/output unit, a measuring unit, and a processing unit. The input/output unit configured to output first information instructing start of welding to an arc welder and receive input of second information indicating generation of an arc by the arc welder. The measuring unit configured to measure a time from the output of the first information to the input of the second information. The processing unit configured to perform predetermined processing when the time or a statistic of the times is equal to or less than a first threshold.

### Effects of the Invention

The control device according to the present disclosure can improve welding quality as compared with conventional art.

### BRIEF DESCRIPTION OF THE DRAWINGS

FIG. 1 is a block diagram showing an example of a welding system according to an embodiment and the main components included in the welding system; and

FIG. 2 is a flowchart showing an example of processing by a processor of a robot control device shown in FIG. 1.

### PREFERRED MODE FOR CARRYING OUT THE INVENTION

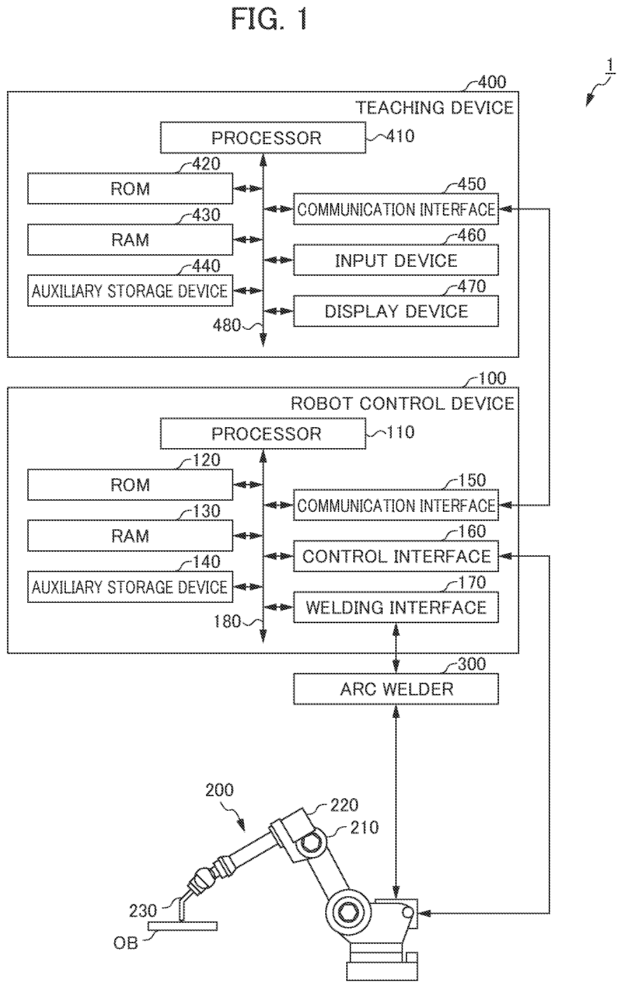

Hereinafter, a welding system according to an embodiment will be described with reference to the drawings. In the drawings used in the following description of the embodiment, the scale of each part may be changed as appropriate. In the drawings used in the description of the following embodiment, the configuration may be abbreviated for the sake of explanation. In the drawings and the specification, the same reference numeral denotes the same element. FIG. 1 is a block diagram showing an example of a welding system 1 according to an embodiment and the main components included in the welding system 1. The welding system 1 is a system for arc welding using a robot arm. The welding system 1 includes, for example, a robot control device 100, a welding robot 200, an arc welder 300, and a teaching device 400.

The robot control device 100 controls the welding robot 200. The robot control device 100 includes, for example, a processor 110, a ROM (read-only memory) 120, a RAM (random-access memory) 130, an auxiliary storage device 140, a communication interface 150, a control interface 160, and a welding interface 170. A bus 180 or the like connects these parts.

The processor 110 is a central part of a computer that performs processing such as calculation and control necessary for the operation of the robot control device 100, and performs various calculation and processing. The processor 110 is, for example, a CPU (central processing unit), MPU (micro processing unit), SoC (system on a chip), DSP (digital signal processor), GPU (graphics processing unit), ASIC (application specific integrated circuit), PLD (programmable logic device), or FPGA (field-programmable gate array). Alternatively, the processor 110 is a combination of two or more of these. Alternatively, the processor 110 may be a combination of any of these and a hardware accelerator or the like. The processor 110 controls the respective parts to implement various functions of the robot control device 100 based on programs such as firmware, system software, and application software stored in the ROM 120, the auxiliary storage device 140, or the like. Furthermore, the processor 110 executes the processing described later based on the programs. Part or all of the programs may be incorporated in the circuitry of the processor 110.

The ROM 120 and the RAM 130 are main storage devices of the computer with the processor 110 as the central part. The ROM 120 is a non-volatile memory used exclusively for reading data. The ROM 120 stores, for example, firmware among the above programs. The ROM 120 also stores data to be used when the processor 110 performs various processing. The RAM 130 is a memory used for reading and writing data. The RAM 130 is used as a work area or the like for storing data to be temporarily used when the processor 110 performs various processing. The RAM 130 is typically a volatile memory.

The auxiliary storage device 140 is an auxiliary storage device of the computer with the processor 110 as the central part. The auxiliary storage device 140 is, for example, an EEPROM (electric erasable programmable read-only memory), HDD (hard disk drive), or flash memory. The auxiliary storage device 140 stores, for example, system software and application software among the above programs. Furthermore, the auxiliary storage device 140 stores data to be used when the processor 110 performs various processing, data generated by processing by the processor 110, various setting values, and the like.

In addition, the auxiliary storage device 140 stores a program for operating the welding robot 200 (hereinafter, referred to as a “robot program”). The robot program determines a start position of arc welding, an operation of a driving part 210, and the like.

The auxiliary storage device 140 stores settings relating to the operation of the robot control device 100 (hereinafter, referred to as “operation settings”). The operation settings include, for example, a setting indicating whether to execute notification processing, a setting indicating whether to execute modification processing, and a setting indicating a value of each threshold and a value of a distance D1. The notification processing, the modification processing, each threshold, and the distance D1 will be described later.

The communication interface 150 is an interface for the robot control device 100 to communicate with the teaching device 400, other devices, and the like. The communication may be wired or wireless.

The control interface 160 is an interface for the robot control device 100 to communicate with the welding robot 200. The communication may be wired or wireless. The robot control device 100 controls the welding robot 200 via the control interface 160.

The welding interface 170 is an interface for the robot control device 100 to communicate with the arc welder 300. The communication may be wired or wireless. The robot control device 100 controls the arc welder 300 via the welding interface 170.

The bus 180 includes a control bus, an address bus, a data bus, and the like, and transmits signals transmitted and received by the respective parts of the robot control device 100.

The welding robot 200 is a device such as a robot that performs arc welding on a to-be-welded object OB. The welding robot 200 changes the relative position of a welding torch 230 and the to-be-welded object OB by moving at least one of the welding torch 230 or the to-be-welded object OB using, for example, a robot arm. Thereby, the welding robot 200 performs welding on the to-be-welded object OB at a desired position. The welding robot 200 includes, for example, the driving part 210, a wire feeder 220, and the welding torch 230. The welding robot 200 may include part or all of the functions of the arc welder 300.

The driving part 210 is a part that is driven by power of a motor such as a servomotor, for example. The driving part 210 includes, for example, a robot arm.

The wire feeder 220 feeds welding wire from a wire supply source to the welding torch 230. In addition, the wire feeder 220 controls the opening and closing of an electromagnetic valve disposed in a supply path of assist gas from an assist gas supply source to the welding torch 230.

The welding torch 230 is a tip instrument provided for arc welding. Welding wire is fed into the tube of the welding torch 230 by the wire feeder 220. The welding torch 230 supplies power supplied from the arc welder 300 to the welding wire. The welding torch 230 includes, for example, a mechanism for ejecting a shielding gas.

The arc welder 300 functions as a power source for supplying electric power required for arc welding to the welding torch 230 or the like. Furthermore, the arc welder 300 has a function of receiving a signal for detecting energization of the workpiece and notifying other devices of the signal. The arc welder 300 may have part of the functions of the welding robot 200.

The teaching device 400 creates a robot program. The creation of the robot program may be performed by online teaching, offline teaching, direct teaching, or any other program creation method. The teaching device 400 is, for example, a teaching pendant capable of performing online teaching. The teaching device 400 is, for example, a device such as a PC (personal computer) that executes software for offline teaching. The robot control device 100 may have part or all of the functions of the teaching device 400. Alternatively, the welding robot 200 may have part or all of the functions of the teaching device 400.

The teaching device 400 includes, for example, a processor 410, a ROM 420, a RAM 430, an auxiliary storage device 440, a communication interface 450, an input device 460, and a display device 470. A bus 480 or the like connects these parts.

The processor 410 is the central part of a computer that performs processing such as calculation and control necessary for the operation of the teaching device 400, and performs various calculation and processing. The processor 410 is, for example, a CPU, an MPU, an SoC, a DSP, a GPU, an ASIC, a PLD, or an FPGA. Alternatively, the processor 410 is a combination of two or more of these. Alternatively, the processor 410 may be a combination of any of these and a hardware accelerator or the like. The processor 410 controls the respective parts to realize various functions of the teaching device 400 based on programs such as firmware, system software, and application software stored in the ROM 420, the auxiliary storage device 440, or the like. Furthermore, the processor 410 executes processing described later based on the programs. Part or all of the programs may be incorporated in the circuitry of the processor 410.

The ROM 420 and the RAM 430 are main storage devices of the computer with the processor 410 as the central part. The ROM 420 is a non-volatile memory used exclusively for reading data. The ROM 420 stores, for example, firmware among the above programs. The ROM 420 also stores data to be used when the processor 410 performs various processing. The RAM 430 is a memory used for reading and writing data. The RAM 430 is used as a work area or the like for storing data to be temporarily used when the processor 410 performs various processing. The RAM 430 is typically a volatile memory.

The auxiliary storage device 440 is an auxiliary storage device of the computer with the processor 410 as the central part. The auxiliary storage device 440 is, for example, an EEPROM, an HDD, or a flash memory. The auxiliary storage device 440 stores, for example, system software and application software among the above programs. The auxiliary storage device 440 stores data to be used when the processor 410 performs various processing, data generated by the processing by the processor 410, various setting values, and the like.

The communication interface 450 is an interface for the teaching device 400 to communicate with the robot control device 100 or the like. The communication may be wired or wireless.

The input device 460 receives an operation by an operator of the teaching device 400. The input device 460 is, for example, a keyboard, a keypad, a touchpad, a mouse, or a controller. Alternatively, the input device 460 may be a device for voice input.

The display device 470 displays a screen for notifying an operator of the teaching device 400 of various information. The display device 470 is, for example, a display such as a liquid crystal display or an organic EL (electro-luminescence) display. Alternatively, a touch panel can also be used as the input device 460 and the display device 470. That is, a display panel included in the touch panel can be used as the display device 470, and a touch pad included in the touch panel can be used as the input device 460.

The bus 480 includes a control bus, an address bus, a data bus, and the like, and transmits signals transmitted and received by the respective parts of the teaching device 400.

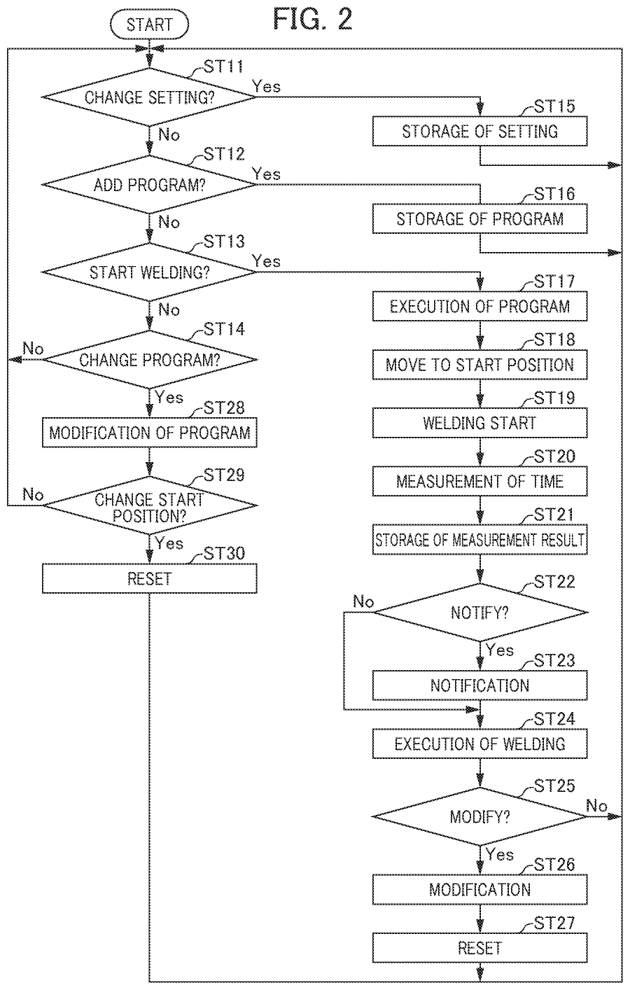

Hereinafter, the operation of the welding system 1 according to the embodiment will be described with reference to FIG. 2 and the like. It should be noted that the contents of the processing in the following operation description are only examples, and various processing capable of obtaining similar results can be used as appropriate. FIG. 2 is a flowchart showing an example of processing by the processor 110 of the robot control device 100. The processor 110 executes, for example, the processing of FIG. 2 based on a program stored in the ROM 120, the auxiliary storage device 140, or the like. The processor 110 starts the processing shown in FIG. 2, for example, when the robot control device 100 is started.

In Step ST11, the processor 110 determines whether to change an operation setting. For example, when receiving an input instructing to change an operation setting, the processor 110 determines to change the operation setting. The input is based on, for example, an operation input by an operator of the teaching device 400. The input is input via the communication interface 150, for example. If the processor 110 does not determine to change an operation setting, the processor 110 determines No in Step ST11, and the processing advances to Step ST12.

In Step ST12, the processor 110 determines whether to newly add a robot program. For example, when receiving an input instructing to add the robot program, the processor 110 determines to add the robot program. The input is based on, for example, an operation input by an operator of the teaching device 400. The input is input via the communication interface 150, for example. If the processor 110 does not determine to add the robot program, the processor 110 determines No in Step ST12, and the processing advances to Step ST13.

In Step ST13, the processor 110 determines whether to start welding. For example, when receiving an input instructing to start welding, the processor 110 determines to start welding. The input is based on, for example, an operation input by an operator of the teaching device 400. The input is input via the communication interface 150, for example. If the processor 110 does not determine to start welding, the processor 110 determines No in Step ST13, and the processing advances to Step ST14.

In Step ST14, the processor 110 determines whether to change a stored robot program. For example, when receiving an input instructing to change a robot program, the processor 110 determines to start welding. The input is based on, for example, an operation input by an operator of the teaching device 400. The input is input via the communication interface 150, for example. If the processor 110 does not determine to change a robot program, the processor 110 determines No in Step ST14, and the processing returns to Step ST11. Thus, the processor 110 is in a standby state in which Steps ST11 to ST14 are repeated until it determines to change the setting, to add the robot program, to start welding, or to change the stored robot program.

If the processor 110 determines to change a setting in the standby state of steps ST11 to ST14, the processor 110 determines YES in Step ST11, and the processing advances to Step ST15. In Step ST15, the processor 110 changes an operation setting based on an input indicating the change content of the operation setting. The input is based on, for example, an operation input by an operator of the teaching device 400. The input is input via the communication interface 150, for example. The processor 110 rewrites an operation setting stored in the auxiliary storage device 140 in order to change the operation setting, for example. After the processing of Step ST15, the processing returns to Step ST11.

If the processor 110 determines to newly add the robot program in the standby state of Steps ST11 to ST14, the processor 110 determines YES in Step ST12, and the processing advances to Step ST16. In Step ST16, the processor 110 stores, in the auxiliary storage device 140, robot programs created by various program creation methods using the teaching device 400. The processor 110 stores a robot program in association with a program ID. The program ID (identifier) refers to identification information unique to each robot program. After the processing of Step ST16, the processing returns to Step ST11.

If the processor 110 determines to start welding in the standby state of Steps ST11 to ST14, the processor 110 determines YES in Step ST13, and the processing advances to Step ST17. In Step ST17, the processor 110 starts executing one of the robot programs stored in the auxiliary storage device 140. The robot program to be started executing here is hereinafter referred to as “execution program”. The processor 110 controls the welding robot 200 and the arc welder 300 based on an execution program. The processor 110 determines which robot program is to be executed based on, for example, an input for selecting a robot program to be executed. The input is based on, for example, an operation input by an operator of the teaching device 400. The input is input via the communication interface 150, for example.

In Step ST18, the processor 110 moves the welding torch 230 to the start position of arc welding based on the execution program.

In Step ST19, the processor 110 outputs a welding start command indicating start of welding from the welding interface 170. The output welding start command is input to the arc welder 300. The arc welder 300 outputs in response to receiving the input of the welding start command. The arc welder 300 generates an arc between the welding torch 230 and the to-be-welded object OB. When the arc has been generated, the arc welder 300 outputs a generation notification indicating that the arc has been generated. The generation notification is input from the arc welder 300 to the welding interface 170 of the robot control device 100. The processor 110 stores a time T1 at which the welding start command was output in the RAM 130 or the like so that the elapsed time from the output of the welding start command can be understood.

The welding start command is an example of first information instructing the start of welding. The generation notification is an example of second information indicating the generation of an arc by the arc welder 300. Accordingly, the welding interface 170 is an example of an input/output unit. The processor 110 that controls the welding interface 170 is an example of an input/output control unit. The arc welder 300 functions as an example of a generation unit by generating an arc in response to receiving an input of a welding start command. Furthermore, the arc welder 300 functions as an example of an output unit by outputting a generation notification indicating that an arc has been generated when an arc has been generated.

In Step ST20, the processor 110 measures the time AT from the output of the welding start command to the input of the generation notification. The processor 110 stores, for example, a time T2 at which the generation notification was input to the welding interface 170 in the RAM 130 or the like. Then, the processor 110 calculates the time AT by subtracting the time T1 from the time T2. The time AT is an example of the time from the output of the welding start command to the input of the generation notification. Accordingly, the processor 110 performs the processing of Step ST20, and thereby functions as an example of a measuring unit configured to measure the time.

In Step ST21, the processor 110 stores the measurement result of the time AT in the auxiliary storage device 140 in association with the program ID of the execution program (hereinafter referred to as “execution ID”).

In Step ST22, the processor 110 determines whether to execute notification processing. The notification processing is processing for notifying an operator or the like of the teaching device 400 that a touch start may occur. For example, when the time ΔT stored in the auxiliary storage device in association with the execution ID satisfies a predetermined condition (hereinafter, referred to as “warning condition”) and the operation setting is set to perform notification processing, the processor 110 determines to execute notification processing. (A1) to (A7) are shown below as examples of warning conditions.

(A1) The number of the times ΔT equal to or less than a threshold TH11 among the times ΔT associated with the execution ID is equal to or greater than a threshold TH12. The value of the threshold TH12 may be 1.
(A2) The ratio of the number of the times ΔT equal to or less than the threshold TH11 to the number of the times ΔT associated with the execution ID is equal to or greater than the threshold TH13.
(A3) The average value of the times ΔT associated with the execution ID is equal to or less than a threshold TH14.
(A4) The median value of the times ΔT associated with the execution ID is equal to or less than a threshold TH15.
(A5) The minimum value of the times ΔT associated with the execution ID is equal to or less than a threshold TH16.
(A6) The maximum value of the times ΔT associated with the execution ID is equal to or less than a threshold TH17.
(A7) The latest time ΔT among the times ΔT associated with the execution ID is equal to or less than a threshold TH18.

The warning condition may be a combination of the conditions (A1) to (A7). Alternatively, the warning condition may be a condition using a statistic other than an average value, a median value, a minimum value, and a maximum value.

In addition, the processor 110 may extract only a predetermined number of the times ΔT associated with the execution ID, starting with the latest, and determine whether the warning condition is satisfied. However, if the number of the times ΔT associated with the execution ID is less than a predetermined number, the processor 110 determines whether the warning condition is satisfied by using, for example, all the times ΔT associated with the execution ID. Alternatively, the processor 110 may extract only the times ΔT measured within a predetermined period from the current time and determine whether the warning condition is satisfied. Alternatively, the processor 110 may exclude outliers and determine whether the warning condition is satisfied. The processor 110 uses, for example, a known method as a method of excluding outliers. Alternatively, the processor 110 may determine whether the warning condition is satisfied only if the number of the times ΔT associated with the execution ID is equal to or greater than a threshold TH19.

The threshold TH11 and the thresholds TH14 to TH18 are examples of a first threshold. The thresholds TH12 and TH13 are examples of a second threshold.

If the processor 110 determines to execute notification processing, the processor 110 determines YES in Step ST22, and the processing advances to Step ST23.

In Step ST23, the processor 110 executes notification processing. For example, the processor 110 instructs the teaching device 400 to display a warning screen on the display device 470 as notification processing.

The processor 410 of the teaching device 400 generates an image corresponding to the warning screen in response to the instruction. The processor 410 instructs the display device 470 to display the generated image. Upon receiving the instruction for display, the display device 470 displays the warning screen.

The warning screen includes, for example, an image indicating that a touch start may be occurring, that a touch start is likely to occur, or that a touch start may occur. It should be noted that characters and the like are also one kind of image. The warning screen also includes, for example, an image that prompts the user to modify the teaching position such as moving the welding torch 230 away from the to-be-welded object OB. Furthermore, the warning screen includes an image indicating an execution ID so that which robot program is the target of the notification processing can be recognized.

Alternatively, the processor 110 may cause a speaker or the like included in the teaching device 400 to output a voice having the same contents as those included in the warning screen as notification processing. Alternatively, the processor 110 may notify the same contents as those included in the warning screen by other methods.

Warning processing is an example of predetermined processing. Accordingly, the processor 110 performs the processing of Steps ST22 and ST23, and thereby functions as an example of a processing unit configured to perform predetermined processing when the time is equal to or less than the first threshold.

After the processing of Step ST23, the processing advances to Step ST24. If the processor 110 determines not to execute notification processing, the processor 110 determines No in Step ST22, and the processing advances to Step ST24.

In Step ST24, the processor 110 executes arc welding on the to-be-welded object by controls the welding robot 200 based on the execution program.

In Step ST25, the processor 110 determines whether to execute modification processing. The modification processing modifies the teaching position of the execution program in order to prevent the occurrence of a touch start. For example, if the time ΔT stored in the auxiliary storage device in association with the execution ID satisfies a predetermined condition (hereinafter, referred to as “modification condition”) and the operation setting is set to perform modification processing, the processor 110 determines to execute modification processing. (B1) to (B7) are shown below as examples of modification conditions.

(B1) The number of the times ΔT equal to or less than a threshold TH21 among the times ΔT associated with the execution ID is equal to or greater than a threshold TH22. The value of the threshold TH22 may be 1.
(B2) The ratio of the number of the times ΔT equal to or less than the threshold TH21 to the number of the times ΔT associated with the execution ID is equal to or greater than a threshold TH23.
(B3) The average value of the times ΔT associated with the execution ID is equal to or less than a threshold TH24.
(B4) The median value of the times ΔT associated with the execution ID is equal to or less than a threshold TH25.
(B5) The minimum value of the times ΔT associated with the execution ID is equal to or less than the threshold TH26.
(B6) The maximum value of the times ΔT associated with the execution ID is equal to or less than a threshold TH27.
(B7) The latest time ΔT among the times ΔT associated with the execution ID is equal to or less than a threshold TH28.

The modification condition may be a combination of the conditions (B1) to (B7). Alternatively, the modification condition may be a condition using a statistic other than an average value, a median value, a minimum value, and a maximum value. It should be noted that the warning condition and the modification condition may be the same condition.

In addition, the processor 110 may extract only a predetermined number of the times ΔT associated with the execution ID, starting with the latest, and determine whether the modification condition is satisfied. However, if the number of the times ΔT associated with the execution ID is less than a predetermined number, the processor 110 determines whether the modification condition is satisfied by using, for example, all the times ΔT associated with the execution ID. Alternatively, the processor 110 may extract only the times ΔT measured within a predetermined period from the current time and determine whether the modification condition is satisfied. Alternatively, the processor 110 may exclude outliers and determine whether the modification condition is satisfied. The processor 110 uses, for example, a known method as a method of excluding outliers. Alternatively, the processor 110 may determine whether the modification condition is satisfied only if the number of the times ΔT associated with the execution ID is equal to or greater than a threshold TH29.

The threshold TH21 and the thresholds TH24 to TH28 are examples of the first threshold. The thresholds TH22 and TH23 are examples of the second threshold.

If the processor 110 determines not to execute modification processing, the processor 110 determines No in Step ST25, and the processing returns to Step ST11. On the other hand, if the processor 110 determines to execute modification processing, the processor 110 determines YES in Step ST25, and the processing advances to Step ST26.

In Step ST26, the processor 110 executes modification processing. For example, the processor 110 rewrites the execution program stored in the auxiliary storage device 140 so that the start position of arc welding in the modification program move away from the to-be-welded object OB by a predetermined distance D1.

The modification processing is an example of predetermined processing. Accordingly, the processor 110 performs the processing of Steps ST25 and ST26, and thereby functions as an example of a processing unit configured to perform predetermined processing when the time is equal to or less than the first threshold.

In Step ST27, the processor 110 performs reset processing targeting the execution program. That is, the processor 110 prevents the times ΔT stored in association with the execution ID from being used in determinations of the warning condition and the modification condition. For example, the processor 110 removes or deletes all the times ΔT associated with the execution ID. After the processing of Step ST27, the processing returns to Step ST11.

An operator or the like of the teaching device 400, for example, modifies a robot program in response to the notification based on notification processing such as seeing a warning screen. An operator or the like, for example, operates the input device 460 to input an instruction to change a robot program in order to modify the robot program. The input is input to the robot control device 100 via the communication interface 150, for example.

If the processor 110 determines to change a robot program in the standby state of Steps ST11 to ST14, the processor 110 determines YES in Step ST14, and the processing advances to Step ST28. In Step ST28, the processor 110 changes the robot program based on an input instructing a change content of the robot program. The input is based on, for example, an operation input by an operator of the teaching device 400. The input is input via the communication interface 150, for example. It should be noted that the robot program changed here is not limited to the robot program that was the target of the notification processing.

In Step ST29, the processor 110 determines whether the start position of arc welding has been changed for the robot program changed in Step ST28. If the start position has not been changed, the processor 110 determines No in Step ST29, and the processing returns to Step ST11. On the other hand, if the start position has been changed, the processor 110 determines YES in Step ST29, and the processing advances to Step ST30.

In Step ST30, the processor 110 performs reset processing targeting the robot program changed in Step ST28. That is, the processor 110 prevents the times ΔT stored in association with the program ID of the robot program from being used in determinations of the warning condition and the modification condition. For example, the processor 110 removes or deletes all the times ΔT associated with the program ID. After the processing of Step ST30, the processing returns to Step ST11.

According to the welding system 1 of the embodiment, when the time ΔT or a statistic of the times ΔT from the output of the welding start command to the input of the generation notification is equal to or less than a predetermined threshold, the robot control device 100 executes predetermined processing such as warning processing or modification processing. Thus, the robot control device 100 can prevent the occurrence of a touch start, and can improve the welding quality as compared with conventional art.

According to the welding system 1 of the embodiment, when the number of the times ΔT equal to or less than a predetermined threshold is equal to or greater than a predetermined number, the robot control device 100 executes predetermined processing. Thus, the welding system 1 according to the embodiment can prevent the predetermined processing from being executed using only one measurement result of the time ΔT when the time ΔT is an outlier.

According to the welding system 1 of the embodiment, the robot control device 100 can use, for example, an average value, a median value, a minimum value, or a maximum value as a statistic of the times ΔT. Thus, the robot control device 100 of the embodiment may be able to execute predetermined processing when a touch start is likely to occur.

According to the welding system 1 of the embodiment, the robot control device 100 performs warning processing as predetermined processing. Thus, the robot control device 100 can prompt an operator or the like of the robot control device 100 to modify the program so as to prevent the occurrence of a touch start.

According to the welding system 1 of the embodiment, the robot control device 100 changes the robot program to move the welding start position away as predetermined processing. Thus, the robot control device 100 can reduce the possibility that a touch start occurs.

According to the welding system 1 of the embodiment, when the start position is changed, the robot control device 100 performs reset processing. Thus, the robot control device 100 prevents the data of the times ΔT before the start position is changed from being used in the warning condition and the modification condition.

The above embodiment can be modified as follows. The processor 110 may perform reset processing if the robot program is changed even though the start position is not changed.

The welding robot 200 may use a filler metal other than welding wire.

The arc welder of the embodiment may not include a robot arm.

The processor 110 or the processor 410 may implement part or all of the processing implemented by the programs in the above embodiment, by way of a hardware configuration of the circuitry.

A program that implements the processing of the embodiment is transferred, for example, in a state stored in a device. However, the device may be transferred in a state in which the program is not stored. The program may be separately transferred and written to the device. For example, the transfer of the program can be realized by recording the program in a removable storage medium or downloading the program via a network such as the Internet or a LAN (local area network).

While an embodiment of the present invention has been described, the embodiment has been presented by way of example only, and is not intended to limit the scope of the invention. Embodiments of the present invention can be implemented in various modes without departing from the gist of the present invention.

### EXPLANATION OF REFERENCE NUMERALS

1 welding system
100 robot control device
110, 410 processor
120, 420 ROM
130, 430 RAM
140, 440 auxiliary storage device
150, 450 communication interface
160 control interface
170 welding interface
180, 480 bus
200 welding robot
210 driving part
220 wire feeder
230 welding torch
300 arc welder
400 teaching device
460 input device
470 display device
OB to-be-welded object

1. A control device, comprising:
an input/output unit configured to output first information instructing start of welding to an arc welder and receive input of second information indicating generation of an arc by the arc welder;
a measuring unit configured to measure a time from the output of the first information to the input of the second information; and
a processing unit configured to perform predetermined processing when the time or a statistic of the times is equal to or less than a first threshold.

2. The control device according to claim 1, wherein the processing unit performs the predetermined processing when a number or a ratio of the times equal to or less than the first threshold among the times measured a plurality of times is equal to or greater than a second threshold.

3. The control device according to claim 1, wherein the statistic is an average value, a median value, a minimum value, or a maximum value.

4. The control device according to any one of claim 1, wherein the processing unit provides, as the predetermined processing, a notification indicating that a program for determining a start position of the welding is to be modified.

5. The control device according to any one of claim 1, wherein the processing unit changes a program for determining a start position of the welding as the predetermined processing to move the start position away from a to-be-welded object.

6. A welding system, comprising:
a control device; and an arc welder,
the control device comprising:
an input/output unit configured to output first information instructing start of welding to the arc welder and receive input of second information indicating generation of an arc by the arc welder;
a measuring unit configured to measure a time from the output of the first information to the input of the second information; and
a processing unit configured to perform predetermined processing when the time or a statistic of the times is equal to or less than a first threshold, and
the arc welder comprising:
a generation unit configured to receive input of the first information and generate the arc; and
an output unit configured to output the second information when the arc is generated by the generation unit.

7. A non-transitory computer readable medium storing a program causing a processor comprised by a control device comprising an input/output unit to function as:
an input/output control unit configured to control the input/output unit to output first information instructing start of welding to an arc welder and receive input of second information indicating generation of an arc by the arc welder;
a measuring unit configured to measure a time from the output of the first information to the input of the second information; and
a processing unit configured to perform predetermined processing when the time or a statistic of the times is equal to or less than a first threshold.
